(19) United States
(12) Patent Application Publication
(10) Pub. No.: US 2015/0348722 A1
(43) Pub. Date: Dec. 3, 2015

(54) SWITCHING CIRCUIT

(71) Applicant: LEGEND CORPORATE SERVICES PTY LTD, Hendon (AU)

(72) Inventors: Steven Fraser, Newport, New South Wales (AU); Philip Anthony Tracy, Epping, New South Wales (AU)

(21) Appl. No.: 14/760,985

(22) PCT Filed: Jan. 15, 2014
(86) PCT No.: PCT/AU2014/000024

§ 371 Date: Jul. 14, 2015

(30) Foreign Application Priority Data
Jan. 16, 2013 (AU) 2013900128

(51) Int. Cl. H01H 9/54; H01H 47/22

(52) U.S. Cl. CPC H01H 9/548; H01H 47/22

(57) ABSTRACT

Disclosed is a switch module (123) for connecting a load (120) to an ac supply (131), comprising an electromechanical switch (107) for (a) connecting, in response to a mechanical ON signal (108) the ac supply to a load, (b) disconnecting, in response to an electrical OFF signal (132) the ac supply from the load; wherein electrical power is not required to maintain the latched open state or the latched closed state, the switch module further comprising a solid state switch (117) in series with the electromechanical switch, a control module (112) for periodically driving the solid state switch from an on state to an off state during part of an ac cycle, and a storage device (115) to receive power from a voltage (118) developed across the solid state switch, for driving the solid state switch, and to provide the electrical OFF signal to the electromechanical switch.

### TECHNICAL FIELD

The present invention relates generally to electric power switches, and in particular, to two-wire switches for connecting a load to a single-phase mains supply.

### BACKGROUND

Lighting circuits in buildings are typically powered from twin-conductor (active and neutral) wiring 301, 302 that is located above the ceiling 306 of the buildings as depicted in FIG. 3. The neutral conductor 302 is typically connected directly to a neutral side 304 of a load such as a ceiling-mounted light fitting 305. Twin-conductor wiring 309, 310 is also typically used to connect a wall switch 308, mounted in a wall 307, in circuit between the above-ceiling active conductor 301 and an active side 303 of the light fitting 305. This wiring method, which is often referred to as switched-active wiring, means that there is no access to the neutral conductor 302 at the wall switch 308. This presents a problem if it is desired to implement intelligent switching involving timer or remote control functions at the wall switch 308, since such functions typically require power to operate, and there is no access to the neutral line 302 at the wall switch 308 and thus power is not readily available.

Current approaches to this problem use a solid state (electronic) switch that is opened for short periods during its nominal closed or ON state time. When the switch is opened the mains supply is available at the wall switch, via the impedance of the load (light fitting etc), and so some small power for the controlling device may be extracted at the wall switch without substantially decreasing the power available at the load. Current switching products use either the electronic switching device alone or in combination with another electrically operable switch.

A disadvantage of using only a single electronic switch is that when it is in the OFF state (ie when the switch is open) the switch will have across it the full amplitude of the mains voltage, as well as any associated transients, and so the switch requires a high voltage rating and most likely some protection against transients. Such switches generally have a significant leakage current which is higher than leakage currents associated with mechanical switches, especially when any protection devices are conducting, and this may not comply with safety regulations.

When a second electromechanical switch such as a relay is used the second switch usually requires significant power for its operation both (a) for switching between an open state and a closed state, and (b) for maintaining the switch in the open state or the closed state, and this larger power is quite difficult to obtain in arrangements as described in FIG. 3. Typically a separate energy storage element such as a capacitor is used to provide the energy necessary to retain their electromechanical switch, some type of relay equivalent to 107, in either its open or closed state. As noted, the safety regulations that generally apply to mechanical switches, relating to mechanical clearances and leakage currents, are very different from those of electronic switches with their over-voltage protection.

### SUMMARY

It is an object of the present invention to substantially overcome, or at least ameliorate, one or more disadvantages of existing arrangements.

Disclosed are arrangements, referred to as “two wire” arrangements, which seek to address the above problems by minimising the power consumption of the electronic switch and the electromechanical switch. In the disclosed two-wire arrangements, it is necessary to be able to extract power from the mains to drive the solid state switch to both the open and closed states (ie the OFF and ON states respectively) because electrical power is required to change the state of the switch from closed to open or open to closed.

According to one aspect of the present invention, there is provided a switching module configured to connect a load to a single phase ac supply, the switching module comprising:

a latching module;

an electromechanical switching device responsive to a force exerted by the latching module, said electromechanical switching device configured to:
transition, in response to a mechanical ON signal, from a latched open state to a latched closed state to thereby connect the ac supply to a connected load;
transition, in response to an electrical OFF signal to the latching module, from the latched closed state to the latched open state to thereby disconnect the ac supply from the connected load; wherein
electrical power is not required to maintain either the latched open state or the latched closed state of the electromechanical switching device;

a solid state switching device connected in series with the electromechanical switching device and the connected load;

a control module configured to periodically drive the solid state switching device from an on state to an off state during a positive part of an ac cycle; and

an energy storage device configured to receive power from a voltage developed across the second switching device, said power being for use by the control module to drive the solid state switching device.

Other aspects of the invention are also disclosed.

### BRIEF DESCRIPTION OF THE DRAWINGS

At least one embodiment of the present invention will now be described with reference to the drawings, in which:

FIG. 1 shows a functional block diagram of the two wire switch;

FIG. 2 shows an example of a latching arrangement that can be used in the arrangement depicted in FIG. 1;

FIG. 3 depicts a typical switched-active wiring scenario in which the disclosed two wire switching arrangement can be used;

FIG. 4 depicts an example of the two-wire switch in FIG. 1 in more detail;

FIG. 5 shows oscilloscope traces associated with the operation of the example of FIG. 4;

FIG. 6 shows an alternate latching arrangement that can be used in the arrangement depicted in FIG. 1;

FIG. 7 shows yet an alternate latching arrangement that can be used in the arrangement depicted in FIG. 1; and

FIG. 8 shows yet another example of a latching arrangement that can be used in the arrangement depicted in FIG. 1.

### DETAILED DESCRIPTION INCLUDING BEST MODE

Where reference is made in any one or more of the accompanying drawings to steps and/or features, which have the same reference numerals, those steps and/or features have for the purposes of this description the same function(s) or operation(s), unless the contrary intention appears.

It is to be noted that the discussions contained in the “Background” section and the section above relating to prior art arrangements relate to discussions of documents or devices that may form public knowledge through their respective publication and/or use. Such discussions should not be interpreted as a representation by the present inventor or the patent applicant that such documents or devices in any way form part of the common general knowledge in the art.

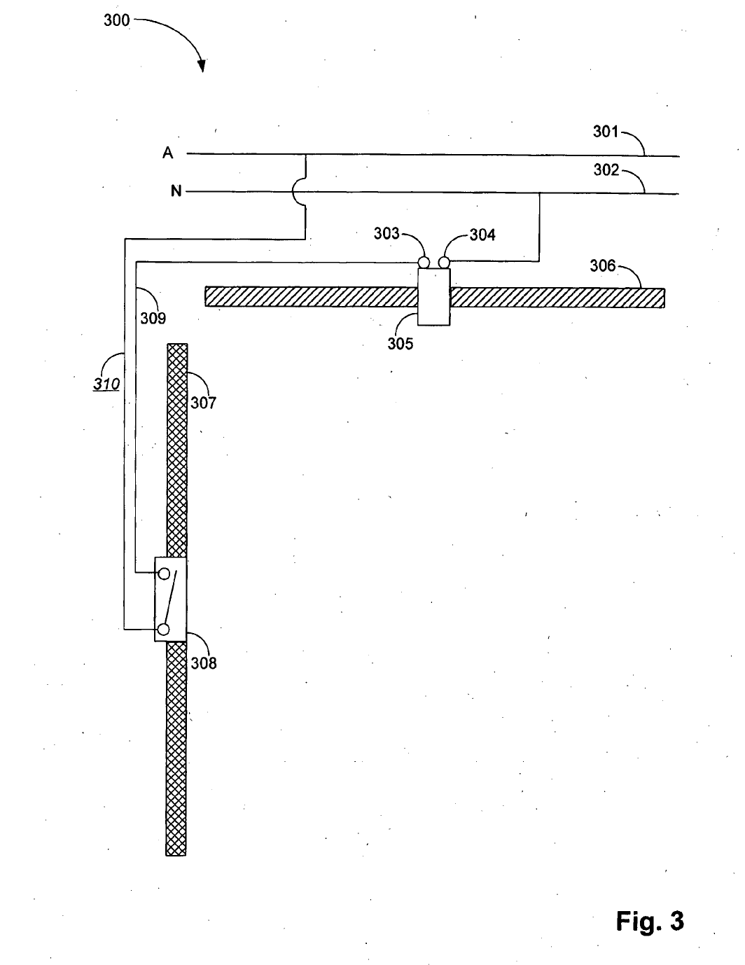

It is advantageous to include a mechanical switch when extracting power at a wall switch 308 as is depicted in FIG. 3, in order to comply with mains supply safety requirements, because the mechanical switch can provide compliant levels of isolation that semiconductor switches generally will not meet.

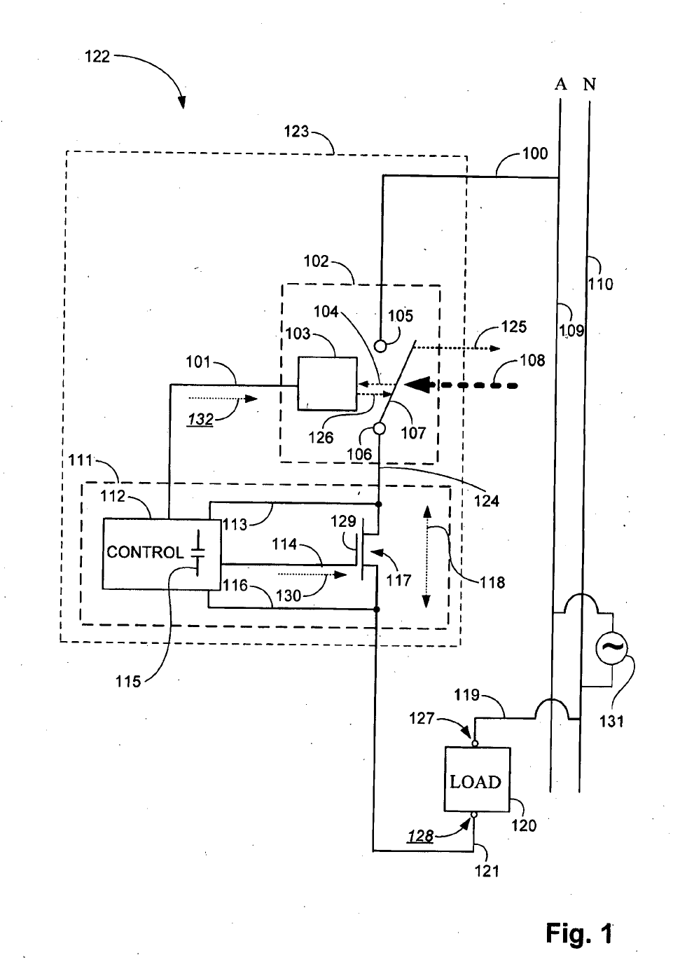

FIG. 1 shows a functional block diagram of a two-wire switch 123. The two-wire switch 123 is configured to switch a load 120 such as a ceiling light having a neutral side 127 that is permanently connected to a neutral line 110 by a connection 119 to a single phase ac supply 131. The two-wire switch 123 connects an active side 128 of the load 120 to an active line 109 by a connection 100 via two series connected switches 117 (which is a solid state electronic switch) and 107 (which is an electromechanical switch).

The two-wire switch can also be used in switched-neutral arrangements in which the side 128 of the load 120 is permanently connected to the active line 109. In this case the two-wire switch 123 connects the side 127 of the load 120 to the neutral line 110 via the two series connected switches 117 and 107.

In one two-wire arrangement the switch 107 is a mechanical switch similar to a relay, and the switch 117 is an electronic switch such as a MOSFET or other suitable device.

In one two-wire arrangement a mechanical retaining spring 125 latches the switch 107 in a latched open state. Any other mechanical retaining arrangement, such as substituting a magnetic force for the spring force, could also provide the means for holding the switch open. A mechanical force 108 (serving as a mechanical ON signal) such as a finger press can overcome the retaining force of the spring 125 and close the switch 107 to thereby transition the switch to a closed latched state. Once closed by the mechanical force 108 the switch 107 remains latched in the latched closed state held, for example, by a magnetic force 104, also referred to as a “first magnetic force”, exerted by a latching module 103. No electrical power is required to maintain the switch 107 in the latched closed position once it is closed by the mechanical force 108. A force 126, also referred to as a “second magnetic force”, opposite to the magnetic force 104 can be applied in order to open the switch 107 to disconnect the ac supply 131 from the load 120, and the retaining spring 125 latches the switch 107 in the latched open state. No electrical energy is required to hold the switch 107 in the latched open state once it is opened by the force 126.

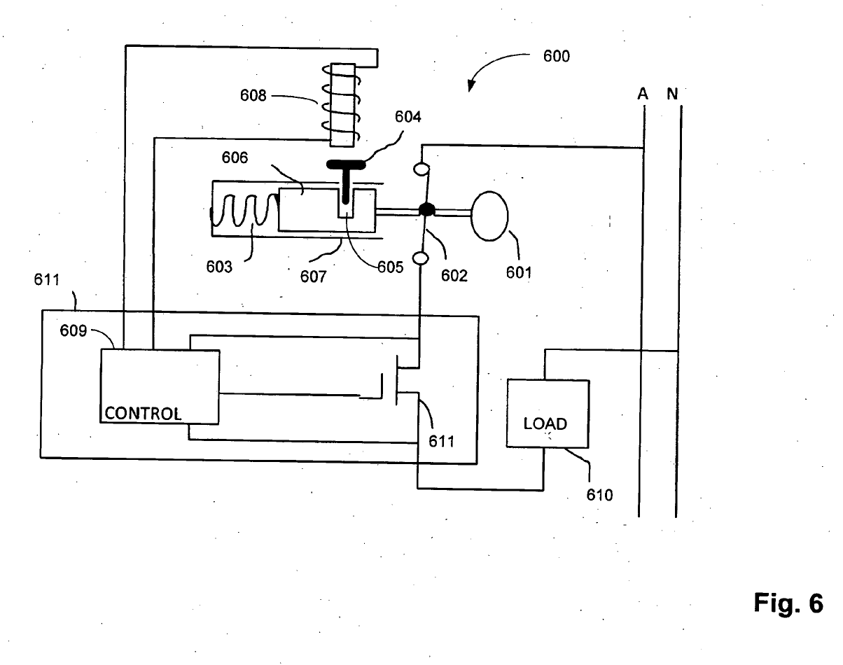

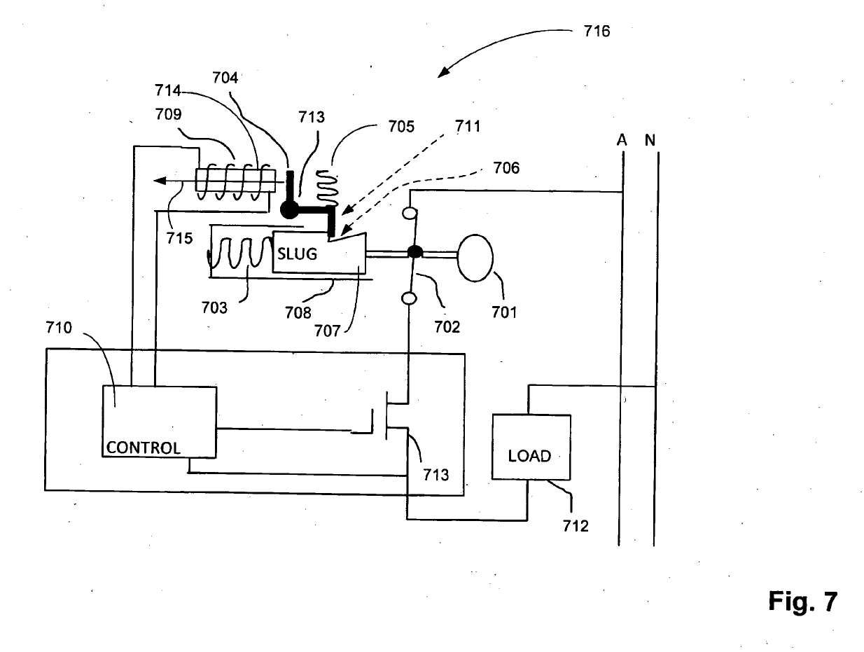

Alternative mechanical arrangements for latching the switch 107 in the closed position can also be used in the disclosed two-wire arrangements. One such example compresses a second, stronger, spring when the switch 107 is closed, and uses a ratchet-like latching arrangement to hold the switch in the closed position. The switch can be released to the open position by disengaging the ratchet. This is similar to arrangements typically found in ball-point pens where the end is pushed to eject the tip and the side is then pushed to retract the tip. A solenoid 201 could be used to create the force necessary to release the ratchet-like retaining arrangement. Alternative arrangements are described hereinafter in more detail in regard to FIGS. 6 and 7.

The control module 112 is configured to provide gate control signals 130 to a gate 129 of the switch 117 via a connection 114 to thereby drive the switch 117 between a non-conducting (ie “off”) state and a conducting (ie “on” state).

When switch 107 is latched closed and while the switch 117 is in the non-conducting state, a voltage 118 is developed across the switch 117. A power-conditioning module (not shown) in a control module 112 generates power, dependent upon this voltage, for the control module 112. The energy required by the control module can be extremely small, of the order of microwatts in some two-wire arrangements. The power-conditioning module uses the power generated by the voltage 118 to charge an energy storage device 115, typically a capacitor.

The energy in the energy storage device 115 is used to ensure the availability of continuous power for the control module 112 as long as the switch 107 in the latched closed state. In order to open the switch 107 in order to remove power from the load 120, a control signal 132 (serving as an OFF signal) in the form, for example, of a short pulse of current can be applied from the energy storage device 115 to the latching module 103 by a connection 101 in order to generate the force 126 in the form of a magnetic force.

In one two-wire arrangement the switch 117 is controlled in such a manner as to be non-conducting and thus generate a sufficient voltage 118 during the first few degrees of each AC cycle. This enables sufficient power to be received by the energy storage device 115 to provide for both the power requirements of the control module 112, and the pulse of energy to the latching module 103 when switch 107 is to be returned to the OFF state.

As described in more detail in regard to FIG. 1, the disclosed two-wire arrangements use a simple yet elegant design which, in one arrangement, utilises the single energy storage device 115 to both provide power for the control module 112 and provide the power necessary to release the switch 107 from the ON state (ie the closed state) to the OFF state (ie the open state). This can provide a distinct advantage in both complexity and cost reduction, and consequent reliability improvement compared to known arrangements in which a separate, second, energy storage element (such as a capacitor) is used to provide the energy necessary to retain the electromechanical switch, some type of relay equivalent to 107, in either its open or closed state.

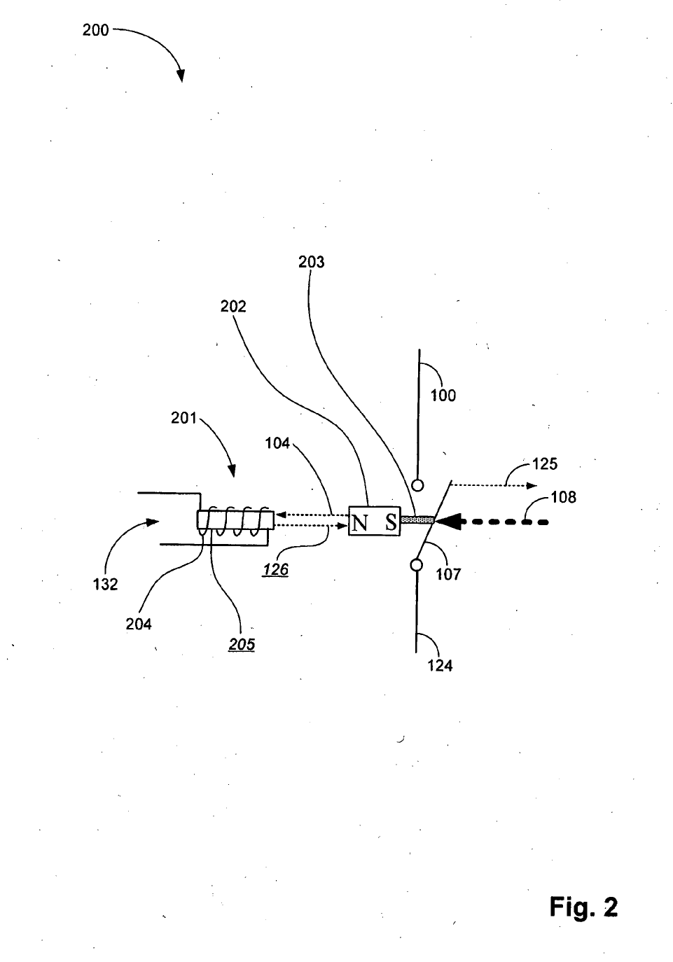

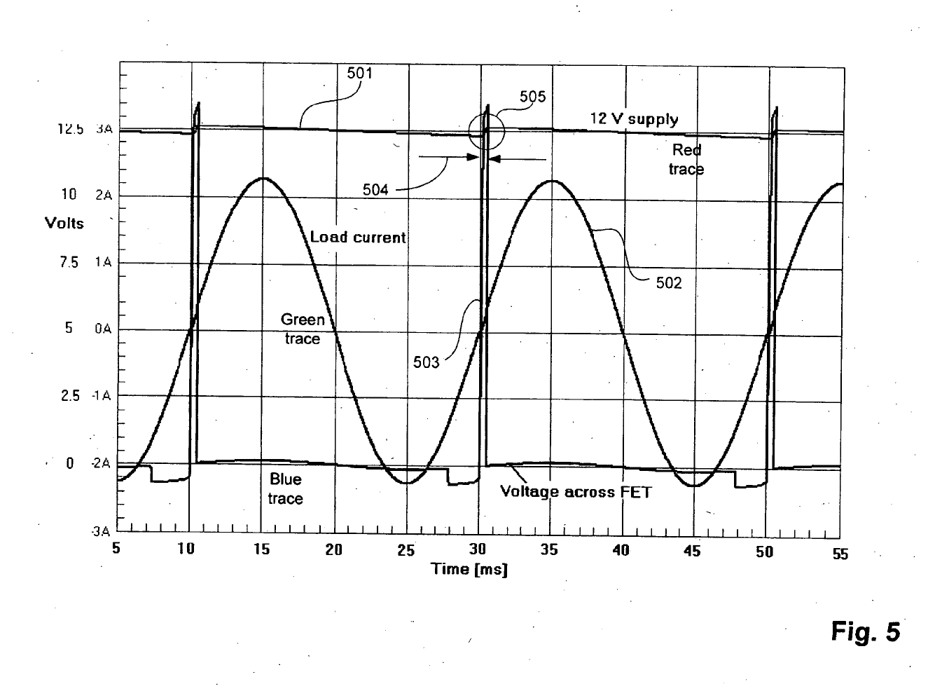

In another two-wire arrangement, it is not necessary to utilise the energy storage device 115 to provide the energy to achieve the release of the mechanically/magnetically latched switch 107 by the module 103. Thus for example an alternative arrangement is to use the pulse of energy (see 118 in FIG. 1 and 503 in FIG. 5) across the switch 117 by extending the duration of the OFF period (ie the open state) during a single half cycle of the ac mains. In such an arrangement a solenoid 201 (see FIG. 2) could, for example, be connected via a series breakdown device such as a zener diode (not shown) across the switch 117 and could be energised by turning OFF the switch 117 (ie driving the switch 117 to the open state) after an extended time such that the voltage across the switch 117 exceeds the series zener voltage and causes current to flow in the solenoid.

The control module 112 performs two functions. The module 112 derives the power needed for its own operation (only) during the time the switch 107 is closed (eg see 503 in FIG. 5) and the module 112 generates the electrical OFF signal necessary to change switch 107 from the latched closed state to the latched open state.

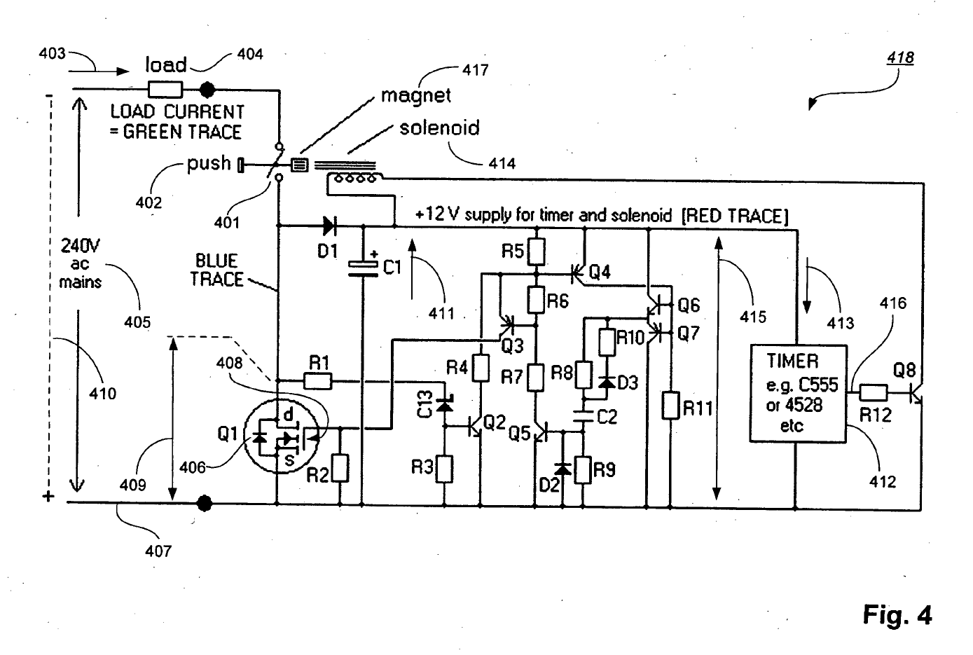

The power is generated in the conventional way by controlling the switch 117 to be periodically non-conducting during a part of each positive cycle of the mains supply 131 near to the time the mains voltage amplitude crosses zero voltage in a positive direction, that is, while the mains has a relatively low voltage amplitude. For example a 230V 50 Hz ac mains supply increases about 0.1V in each microsecond after crossing its zero value. If the switch 117 is made non-conductive for 100 microseconds after the mains crosses zero voltage this will make available a 10 V peak voltage that can be used to charge the capacitor 115. The voltage developed across the switch 117 is connected via a diode to the energy storage device 115 (eg see the diode D1 and the energy storage device C1 in FIG. 4)

The control signal 130 to drive the gate of the switch 117 depends upon sensing the voltage 118 in FIG. 1 or the voltage 409 in FIG. 4 developed across respective switches 117 in FIGS. 1 and 406 in FIG. 4. It is noted that the voltage across the switch 117 crosses from negative to positive polarity, as the ac mains 131 voltage crosses through zero. At or near the zero crossing point of the mains voltage 131, the drive signal 130 is removed and a timer that controls the drive signal 130 is started. When the timer reaches around 100 to 300 ns the drive to the switch 117 is re-applied.

As an alternative to using the 100-300 μs timer, the voltage 118 across the switch 117 can be monitored and when the voltage 118 reaches a selected voltage level, normally less than about 30 V, the drive is re-applied.

FIG. 2 shows an example of a latching arrangement that can be used in the arrangement depicted in FIG. 1. In this example the switch 107 is coupled, as depicted by a member 203, to a permanent magnet 202. The latching module 103 is implemented as a solenoid 201 with windings 204 wound on a magnetic core 205, using ferrous material for example. The term “magnetic core” means a core made from a material, such as steel, that can be attracted by a magnet or a solenoid. The mechanical force 108 overcomes the retaining force of the spring 125 and closes the switch 107. Once closed by the mechanical force 108 the switch 107 remains latched in the latched closed position held, in this example, by the magnetic force 104 exerted by the permanent magnet 202 on the ferrous core 205 of the solenoid 201. No electrical energy is required to hold the switch 107 in the latched closed position once it is closed by the mechanical force 108. The force 126 opposite to the magnetic force 104 can be generated in order to open the switch 107 by providing, as depicted by the arrow 132, a short pulse of current from the energy storage device 115 to the solenoid 201 which generates a magnetic field in the solenoid core 205 that develops the magnetic force 126 which causes the permanent magnet 202 to be repelled away from the solenoid core 205 and the retaining spring 125 latches the switch 107 in the open position. No electrical energy is required to hold the switch 107 in the open position once it is opened by the force 126.

FIG. 4 depicts an example of the two-wire switch in FIG. 1 in more detail. When a magnetically latching mechanical switch 401 is manually closed by applying a mechanical force 402, a current 403 will flow from the 240 V ac mains 405 via a load 404 into a Field Effect Transistor (FET) Q1 that could be IRFP460 or any one of many similar parts with a low ON resistance. This type of FETs has an internal, reverse connected, diode 406 so that when a mains polarity is negative with respect to the lower common supply rail 407, as depicted by a dashed line 410, the load current 403 will simply flow in that diode 406. To further reduce power dissipation in the FET's diode 406 a second Schottky diode, having an even lower forward voltage, could be conventionally connected in parallel with the FET Q1 but for simplicity this is not shown.

A gate 408 of the FET is driven from a monostable latch circuit that will initially be in an OFF state and consequently the gate 408 of the FET Q1 will initially not be driven so that the FET Q1 will be an OFF state. As the mains 405 starts a positive half cycle the FET Q1 is in the OFF state so the load current 403 will flow via a diode D1 into a power supply capacitor C1 and will charge C1.

When a voltage 409 across the FET Q1 reaches approximately 13V a zener diode C13 will conduct and drive a connected transistor Q2 into an ON state. Current will then flow via a resistor R4 in the collector circuit of Q2, which will turn a monostable latch, consisting of an uppermost transistor Q4 and a lower transistor Q5 into an ON state. That in turn provides gate drive, via an emitter follower Q3, to the FET gate 408 and will turn the FET Q1 into the ON state. The load current 403 will then flow through the low ON resistance of the FET Q1 and the power dissipation of the FET Q1 will be small even for high load currents 403.

FIG. 5 shows oscilloscope traces associated with the operation of the example of FIG. 4. In FIG. 5 the voltage 409 across the FET Q1 is shown by a trace 503. It can be seen that the voltage 409 across the FET is available to change the power supply capacitor for only a very short period 504 at the start of each positive half cycle of the mains. A DC voltage 411 generated across the capacitor C1 is shown by a trace 501 and can be seen to be charged during a short time period 505 during which the FET Q1 is not conducting and then maintained by the storage capacitor C1. The example depicted in FIG. 4 supports a timer circuit 412 which draws a current 413 of approximately 1 mA, more than sufficient for most timer devices including microcontroller based timers.

The monostable latch has a time-out period that lies between 10 ms and 20 ms, preferably close to 18 ms, so that the FET gate 408 will be turned OFF at some time during the negative mains half cycle and remain OFF and ready to be triggered ON again at the start of the next positive half cycle as described above. To ensure a fast reset time for the monostable latch, its output is buffered by transistors Q6 and Q7 and a low resistance discharge path for the timing capacitor C2 is provided by R10, D2, D3.

To operate a solenoid 414, and cause total disconnection of the mains 405 from the load 404, any conventional electronic timer IC 412, for example a CMOS 555 timer or an HEF4528 monostable latch can be used. That timer 412 is simply arranged to be reset when a 12V power supply 415 is applied and to generate a pulse at 416 on expiry of the required period. The timer pulse at 416 drives a transistor Q8 to connect the 12 V supply 415 to the solenoid 414 with a polarity that will cause a magnet 417 to be repelled from the solenoid 414 thereby causing the switch 401 to be opened.

Note that when the magnetically latching switch 401 is opened all power is removed from the control circuit and from the load. The supply capacitor C1 will discharge over a time period but will be quickly re-charged, during the time period 505 next time power is connected by activating (ie closing) the switch 401. Note that, while it will actually happen quickly, it is not necessary for the power supply provided for the solenoid by the capacitor C1 to be charged quickly. The push switch 401 is magnetically latched. It is only necessary that the power supply provided by the capacitor C1 be available by the time it is required to operate the solenoid 414 to turn the load 404 to the OFF state. The monostable latch has minimal powering requirements and could have alternative powering arrangements.

FIG. 6 shows an example of a mechanically latching arrangement 600 that could be used in place of the magnetic latching arrangement depicted in FIG. 1. In FIG. 6 a switch 602 is shown in the latched closed position, after a manual button 601 has been pushed in order to compress a spring 603 and allow a pin 604 to drop, or to be forced by another spring (not shown), into a recess 605 in a slug 606 that slides inside a tube 607. The pin 604 is made of a material, such as steel, that can be attracted by a magnet or a solenoid. When it is required to open the switch 602 a solenoid 608 is momentarily activated by a current from a control module 609 causing the pin 604 to be withdrawn from the slug 606 which causes the switch 602 to open under action of the spring 603 which drives the slug 606. Other mechanically latching arrangements, together with an electromagnetically operated release mechanism, can also be used.

FIG. 7 shows another example of a mechanically latching arrangement 716 that could be used in place of the magnetic latching arrangement of FIG. 1. In FIG. 7 a switch 702 is shown in a latched closed position, after a manual button 701 has been pushed in order to compress a spring 703 and thereby allow a ratchet-like arrangement consisting of an armature 704 pivoting about a pivot point 713 to be forced by another spring 705, into a recess 706 in a slug 707 that slides inside a tube 708. The armature 704 is made of a material, such as steel, that can be attracted by a magnet or a solenoid. When it is required to open the switch 702 a solenoid 709, wound on a magnetic core 714, is momentarily activated by a current from a control module 710 causing the armature 704 to be attracted to the solenoid 709, as depicted by an arrow 715, and thereby a retaining part 711 of the armature 704 is withdrawn from the recess 706 in the slug 707 so that the switch 702 will be opened under the action of the spring 703 driving the slug 707 forward in the tube 708. Clearly similar mechanically latching arrangements, together with an electromagnetically operated release mechanisms, could also be used.

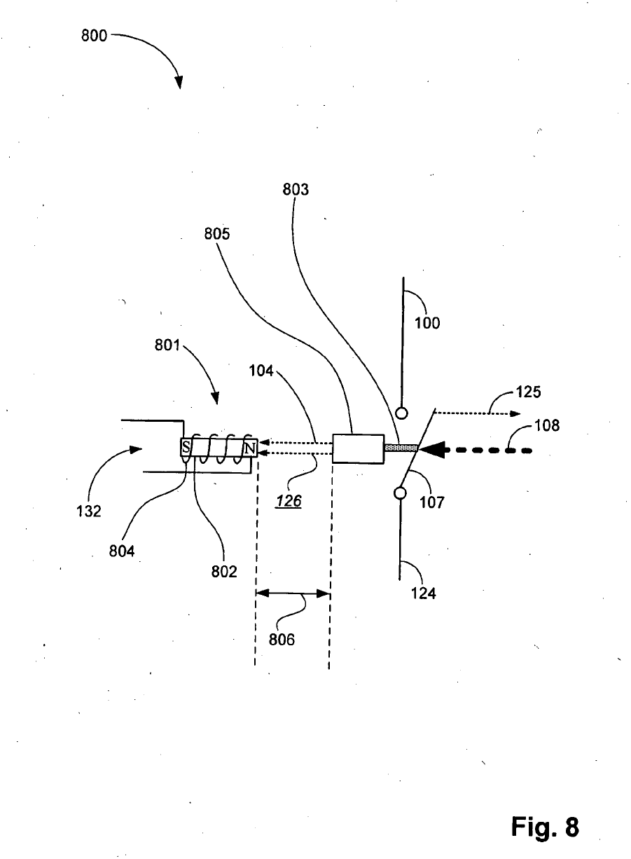

FIG. 8 shows yet another example 800 of a latching arrangement that can be used in the arrangement depicted in FIG. 1. In this example the permanent magnet and the core of the solenoid, which is made of a material capable of being magnetised or attracted to a magnet, are swapped around. The switch 107 is coupled, as depicted by a member 803, to a piece of material 805 capable of being magnetised or attracted to a permanent magnet, for example a piece of ferrous material. The latching module 103 is implemented as a solenoid 801 with windings 804 wound on a permanent magnet core 802. The mechanical force 108 overcomes the retaining force of the spring 125 and closes the switch 107. Once closed by the mechanical force 108 the switch 107 remains latched in the latched closed position held, in this example, by the magnetic force 104 exerted by a magnetic field of the permanent magnet 802 on the ferrous material 805. No electrical energy is required to hold the switch 107 in the latched closed position once it is closed by the mechanical force 108.

As described below, the magnetic force 104 is reduced to a very much reduced, near zero force, depicted by a reference numeral 126, in order to open the switch 107 by providing, as depicted by the arrow 132, a short pulse of current from the energy storage device 115 to the solenoid 801. This generates a magnetic field of the solenoid 804 which acts in opposition to the magnetic field of the permanent magnet 802 forming the solenoid core. This opposing magnetic field of the solenoid reduces the magnetic force 104 exerted by the magnetic field of the permanent magnet 802 which attracts the ferrous material 805. The reduction of the magnitude of the magnetic force 104 (depicted by the reduced magnitude force 126) is sufficient to enable the ferrous material 805 to be moved away from the solenoid core 802 by the force of the retaining spring 125.

The difference between the arrangement in FIG. 8, where the permanent magnet and the ferrous core of the solenoid have been swapped/interchanged with respect to the arrangement in FIG. 2, is that in the arrangement of FIG. 2 the force 104 exerted between the magnet 202 and the solenoid core 205 is an ‘attraction’ of the magnet to the ferrous material. When the current is applied to the solenoid winding in FIG. 2, as depicted by the arrow 132, the current is arranged to produce in the solenoid core 205 an ‘electromagnet’ which has its North pole on the right hand end of the solenoid 201 and which therefore generates the force 126 in the opposite direction to the force 104 as shown. The force 126 is thus a repulsion force. The two North poles, ie the North pole of the permanent magnet 202 and the North pole of the solenoid 201 thus repel each other.

In the arrangement of FIG. 8, the force 104 is the same attraction force as is generated between the permanent magnet 202 and the ferrous core 205 in FIG. 2. However, when the current is applied to the solenoid in FIG. 8, as depicted by the arrow 132, the effect is to ‘nullify’ the attraction force 104 of the permanent magnet 802 by creating a roughly equal, but opposite, magnetic field. The field of the solenoid 801 thus effectively reduces the attraction force 104 of the permanent magnet 802 on the core 805 to approximately “zero” and the spring 125 then opens the switch.

If the current depicted by the arrow 132 in the solenoid 801 is too small, some attraction force 104 will remain (ie the low magnitude force 126 will not be close to zero). If the current depicted by the arrow 132 is ‘just right’ the attraction force 104 (depicted by the low magnitude force 126) becomes approximately zero. If the current in the solenoid 801 is too large it will overcome the permanent magnet's field (which produces a North pole on the right) and will produce a new net magnetic attraction on the core 805 with a South pole replacing the original permanent magnet's North pole. The resultant net force 126 in this case will be too large, ie greater than spring force 125, and the mechanism may not release.

The objective therefore is to ensure that the solenoid current depicted by the arrow 132 produces a “very much reduced, near zero” net attraction force, depicted by the arrow 126, on the ferrous part 805 so the spring force 125 can overcome the net force 126 and the switch will open.

Once the ferrous material 805 is separated from the permanent magnet 802 by a sufficient distance 806, the force 104 exerted by the permanent magnet 802 on the ferrous material 805, after removal of the pulse of current from the energy storage device 115, is less than that of the retaining spring 125 which will then hold the switch 107 latched in the open position. No electrical energy is required to hold the switch 107 in the open position once it is opened.

### INDUSTRIAL APPLICABILITY

The arrangements described are applicable to the power and lighting industries and particularly for application in building wiring.

The foregoing describes only some embodiments of the present invention, and modifications and/or changes can be made thereto without departing from the scope and spirit of the invention, the embodiments being illustrative and not restrictive.

1. A switching module configured to connect a load to a single phase ac supply, the switching module comprising:
a latching module;
an electromechanical switching device responsive to a force exerted by the latching module, said electromechanical switching device configured to:
transition, in response to a mechanical ON signal, from a latched open state to a latched closed state to thereby connect the ac supply to a connected load;
transition, in response to an electrical OFF signal to the latching module, from the latched closed state to the latched open state to thereby disconnect the ac supply from the connected load; wherein
electrical power is not required to maintain either the latched open state or the latched closed state of the electromechanical switching device;
a solid state switching device connected in series with the electromechanical switching device and the connected load;
a control module configured to periodically drive the solid state switching device from an on state to an off state during part of a positive ac cycle; and
an energy storage device configured to receive power from a voltage developed across the second switching device, said power being for use by the control module to drive the solid state switching device.

2. The switching module according to claim 1, wherein the power received by the energy storage device is also used to provide the electrical OFF signal to the latching module.

3. The switching module according to claim 1, further comprising a breakdown device connected across the solid state switching device, wherein:
the duration of the part of the ac cycle during which the solid state switching device is in the OFF state ensures that the voltage developed across the second switching device exceeds a breakdown voltage of the breakdown device; and
a current flowing through the breakdown device when the breakdown voltage is exceeded provides the electrical OFF signal to the latching module.

4. The switching module according to claim 1, wherein the control module drives the solid state switching device from the on state to the off state while the electromechanical switching device is in the latched closed state.

5. The switching module according to claim 1, wherein the latching module comprises:
a solenoid wound on a magnetic core;
a mechanical retaining spring coupled to the electromechanical switch; and
a member coupling a permanent magnet to the electromechanical switch wherein the electromechanical switch:
is latched in the latched open state by the retaining spring;
is latched in the latched closed state by a first magnetic force between the permanent magnet and the magnetic core; and wherein:
the electromechanical switch is driven to the latched open state by a magnetic force generated by the solenoid upon the latching module receiving the OFF signal, said second magnetic force repelling the permanent magnet.

6. The switching module according to claim 1, wherein the latching module comprises:
a solenoid wound on a magnetic core;
a mechanical retaining spring; and
another mechanical spring;
wherein the electromechanical switch:
is maintained in the latched open state by the mechanical retaining spring;
is maintained in the latched closed state by a ratchet; and wherein:
the other mechanical spring is urged to a compressed state when the switch is open; and
the electromechanical switch is driven to the latched open state by the other mechanical spring returning to a compressed state when a magnetic force (126), generated by the solenoid upon the latching module receiving the OFF signal, disengages the ratchet.

7. The switching module according to claim 1, wherein the latching module comprises:
a solenoid wound on a permanent magnetic core;
a mechanical retaining spring coupled to the electromechanical switch; and
a member coupling a piece of magnetisable material to the electromechanical switch; wherein the electromechanical switch:
is latched in the latched open state by the retaining spring; and
is latched in the latched closed state by a magnetic force between the permanent magnet core and the magnetisable material; and wherein:
the electromechanical switch is driven to the latched open state by the spring when the magnetic field generated by the solenoid is arranged to oppose the magnetic field generated by the permanent magnet upon the latching module receiving the OFF signal, thereby causing the magnetic force on the magnetisable material to be smaller than the force exerted on it by the spring.
